(19) United States
(12) Patent Application Publication
(10) Pub. No.: US 2016/0347592 A1
(43) Pub. Date: Dec. 1, 2016

(54) LIFTING GEAR WITH HYSTERESIS CLUTCH

(71) Applicant: Konecranes Global Corporation, Hyvinkää (FI)

(72) Inventor: Markus GOLDER, Künzelsau (DE)

(21) Appl. No.: 15/117,243

(22) PCT Filed: Feb. 9, 2015
(86) PCT No.: PCT/EP2015/052651

§ 371 Date: Aug. 8, 2016

(30) Foreign Application Priority Data
Feb. 11, 2014 (DE) 10 2014 101 654.8

(51) Int. Cl. B66D 1/58; B66D 3/22; H02K 49/06

(52) U.S. Cl. CPC B66D 1/58; H02K 49/065; B66D 3/22

(57) ABSTRACT

A lifting hoist (10) having a powertrain (14) that includes a hysteresis clutch (23) for transmitting torque from a driving motor (15) to a transmission for moving a load pulling element (11). The hysteresis clutch (23) can be set to incur a slippage differing significantly from zero before a nominal load bearing capacity (FNom) of the hysteresis clutch is reached by the pulling element (11). Hence, when the lifting hoist operates within the range at or near the nominal load-bearing capacity (FNom), it is operable with continuous slip. The waste heat generated in the process is preferably transferred to the wall of the transmission housing via an oil bath, with the wall serving as a cooling surface. The lifting hoist can be built smaller and has improved operating properties.

### FIELD OF THE INVENTION

The present invention relates generally to hoists, and more particularly, to hoists having a powertrain comprising a hysteresis clutch.

### BACKGROUND OF THE INVENTION

Hoists are used for lifting loads by means of chains, ropes or other pulling means. Such hoists are driven by a motor, in which case a transmission is provided between the pulling means and the motor.

It must be ensured that any overloading of the pulling means, the transmission or any other components of the hoist—even in the case of a faulty operating status such as, for example, a load being caught on an obstacle—does not result in any damage to the chain pulley block and, in particular, does not result in the dropping of the load. This applies, in particular, if the hoist is used in horizontal pulling operations, for example, in order to drive traversing gears or carriages.

To accomplish this, U.S. Pat. No. 3,573,518 describes a hoist with a powertrain consisting of a motor and a transmission and having a hysteresis clutch. The hysteresis clutch is accommodated in its own housing that is arranged in an extension of the motor housing. The hysteresis clutch is driven by the motor shaft and is itself connected to the input shaft of the transmission. The hysteresis clutch comprises a motor-driven rotor provided with permanent magnets and a disk arranged at a minimal distance from said rotor, said disk consisting of hysteretic magnetizable material. A disk-shaped air gap is formed. In addition, the disk is electrically conductive in order to generate slippage-induced vortices. A thermo-switch connected to the disk is disposed to stop the drive if a slippage occurring on the hysteresis clutch will not disappear after a short time. In doing so, the hysteresis clutch is adapted so that it permits a slippage only in the case of an overload and otherwise effects a non-torsional coupling between the two clutch halves. In addition, the clutch is only effective unidirectionally in upward direction. In opposite direction, the action of the hysteresis clutch is prevented by a freewheel arranged parallel to the hysteresis clutch. The freewheel is disposed to overcome the brake moment of a load pressure brake when the load is being lowered. The motor starting torque required therefor is greater than the torque for lifting the nominal load.

### OBJECTS AND SUMMARY OF THE INVENTION

It is an object of the present invention to provide an improved hoist that has a torque limit at which a hysteresis clutch thereof begins to slip without mechanical friction. The torque of the slippage is smaller than the torque of the nominal load. In doing so, the torque of the nominal load is that moment of torsion that occurs on the clutch when the hoist lifts the nominal load, i.e., its maximum permitted load. In doing so, the slippage represents the difference between the rotational speeds of the two clutch halves, divided by the rotational speed of the motor-driven clutch half. Due to the slippage occurring before the load-bearing capacity is reached, the operation of the hoist can be improved in several respects.

When a load is lifted, in particular when it is lifted at a high lifting rate, a chain or an appropriate rope coupled with the load is initially slack. With a fast-moving drive, the latter becomes taut and lifts the load with a jolt. By providing a slippage of the hysteresis clutch before the pulling means builds up a pulling force corresponding to the nominal load, the load shock is cushioned considerably. Damaging reactions on the pulling means, the remainder of the powertrain or the supporting structure of the hoist of the crane system, or the like, are avoided or at least considerably reduced.

Setting the torque of the nominal load greater than the torque limit additionally allows a more intuitive handling of the hoist than before. In particular, when unknown or varying loads are being lifted, the subject hoist provides feedback regarding the size of the load to the operator in the course of daily practical operations. With a constant rotational speed of the motor that is to be driven, loads that are smaller than the nominal load but exceed the torque limit are lifted visibly slower than loads that are smaller than the maximum permitted load (with which the torque limit would be reached). Consequently, the operator perceives when the nominal load is being approached as a result of a noticeably slower lifting of the picked-up load.

Inasmuch as the hysteresis clutch exhibits a slippage already at a partial load that is clearly lower than the nominal load, a gentle startup of the hoist can be achieved even without the use of an inverter control of the motor. For example, the force of acceleration required for accelerating a suspended load in lifting direction causes the slippage to increase at the time the motor is switched on, so that the load can accelerate more slowly than the motor. This also applies to rotational speed reversals when the motor very rapidly changes its rotational speed and, for a time being, increased slippage in the hysteresis clutch allows reduced accelerations of the load and thus a minimization of the acting forces. A similar behavior can also be achieved when the motor is being switched off.

In particular, the hysteresis clutch allows the efficient absorption of vibrations due to the damping effect that is not a function of the rotational speed of said clutch. Such vibrations are triggered by switching the motor on and off, by rotational speed reversals or also by the polygon effect in chain pulleys (vibration triggering of the tensioned chain as a result of changing radii on the chain wheel). In this manner, it is possible to prevent that the load-bearing capacity is being exceeded due to the resonant vibrations of the chain and that a shutdown or other counter-measures are necessitated.

The torque limit at which the hysteresis clutch begins to develop a slippage different from zero can be set—appropriate for the purpose—for example, to at most to 0.95 times, 0.9 times, 0.8 times or to the nominal load torque or to another ratio thereto. The lower the torque limit is set, the more slippage is allowed by the hysteresis clutch during normal operation and the greater are the aforementioned effects.

Preferably, the hysteresis clutch features an increasing transmitted torque with increasing slippage. In doing so, it is ensured that torques above the torque limit can be transmitted. In this way, the hysteresis clutch can allow the lifting of loads that are minimally greater than the nominal load. The slippage may be up to 1 (i.e., 100%). Preferably, the force generated by the hoist at slippage 1 is within a tolerance range of forces that do not lead to any damage of the hoist or its supporting structures.

The hysteresis clutch can be designed to allow a longer period of operation at high slippage, without the motor being switched off. In this case, the hysteresis clutch provides a passive protection of the hoist and its supporting structure, in which case the forces limited by the hysteresis clutch may be trusted when dimensioning said hoist and said supporting structure. This allows the minimization of the otherwise to be implemented added safety features in dimensioning the system, without having to accept a reduction of safety.

The hysteresis clutch can be connected to a rotary speed detector. The latter comprises at least one means that is a function of the rotational speed and/or the rotary angle such as, e.g., a rotational speed sensor, a centrifugal switch, a resolver or the like. The rotational speed detecting means may be configured as an absolute value generator or an incremental generator. Preferably, the rotational speed detecting means is associated with at least the output-side clutch half in order to monitor said half in view of its rotational speed. Optionally, another rotational speed detecting means can detect and monitor the input-side clutch half. This rotational speed detecting means may also be installed in the motor. Rotational speed detecting means of any of the aforementioned designs will be generically referred to hereinafter as “rotational speed sensor”.

An analyzing device can compare the rotational speeds detected by the rotational speed sensors and determine, in particular, the rotational speed differences. The rotational speed difference (motor-side clutch rotational speed minus the transmission-side clutch rotational speed) divided by the motor-side clutch rotational speed represents the slippage. Preferably, the slope of the torque/slippage characteristic rises linearly. Above the torque limit, the detected slippage may be used as a measure for the force applied by the hoist. This also applies to non-linear torque/slippage relationships.

Referring to an advantageous embodiment, the hysteresis clutch is arranged in an oil bath. This oil bath can be part of the oil filling of the transmission or it may represent a separate oil volume. The hysteresis clutch may be arranged in the transmission housing. In both cases, the oil bath can be used efficiently for cooling the hysteresis clutch in that said bath absorbs the thermal energy generated on one clutch half and discharges it to the housing of the hoist in order to conduct the thermal energy into the environment. In particular, the hysteresis clutch may be in contact with an oil flow that is formed by the transmission oil. As a result of this, the energy transformed by the slippage into thermal energy can be discharged in such an efficient manner that the continuous operation of the hoist with slippage is made possible.

Preferably, the hysteresis clutch has a cylindrical design with a permanently magnetic rotor on the inside and a hollow cylindrical hysteresis ring on the outside, said ring potentially being subject to considerable heating during operation. By arranging said ring on the outside, simple and efficient cooling is possible.

The air gap of the hysteresis clutch may be free of oil or, if needed, also be filled with oil. In the latter case, the oil present in the air gap may result in an additional transmission of torque due to its viscosity and/or due to its hydrodynamic effects. It is possible to utilize the reduction of the oil viscosity concomitant with the heating of the oil in the air gap for the reduction of the torque transmission with an existing overload in order to keep the operator from further overloading the hoist.

Preferably, the hysteresis clutch has a size-adjustable air gap. Referring to a cylindrical air gap, an axial adjustment of at least one clutch half—with the radial air gap width remaining the same—can be used for the axial size reduction of said air gap width in order to adjust the torque limit as desired.

Referring to a hysteresis clutch having a conical air gap, an axial adjustment of at least one of the clutch halves can be used to adjust the air gap in view of its radial width, as well as its axial width, and its length, respectively. By adjusting the size of the air gap, it is possible to adjust or set the torque limit and/or the form and/or the slope of the torque/slippage characteristic.

An advantageous embodiment of the hoist has a powertrain comprising at least one brake, wherein at least one of the brakes is arranged on the transmission side, viewed from the hysteresis clutch. If the brake connected to the transmission is designed for a brake torque that is at least as great as the sum of the maximum load torque and the maximum torque that can be applied by the hysteresis clutch or the motor—depending on which is the lesser—a safety-oriented drive can be produced. The brake will be able to hold the load even if the motor is rotating uncontrolled in any direction, while the hysteresis clutch limits the transmitted torque to a value that can still be safely absorbed by the brake. Should such an error status continue to exist, the hysteresis clutch that operates mechanically in a contactless manner can reach a temperature at which one or more permanent magnets become weaker or demagnetize entirely. As a result of this, the torque transmission is attenuated or interrupted. Additional heating and dangerous overheating of the drive are thus prevented. This applies to hoists with thyristor-controlled drives, as well as to hoists with power mains-controlled drives.

This arrangement offers several advantages:

When an emergency switch is actuated, the brake stops the transmission and the pulling device. In the hysteresis clutch, the kinetic energy of the rotating motor is converted into thermal energy—without overloading the transmission or the clutch. This concept is particularly suitable for use in motors exhibiting a high rotational speed of more than 1500 or even more than 3000 revolutions per minute, these exhibiting a particularly high kinetic energy during operation.

Furthermore, this concept is suitable for safety-oriented drives. For example, if the motor is driven via an inverter that does not comply with the regulations for a safety-oriented inverter, the desired safety can still be achieved by the combination of brake and hysteresis clutch. This is true, in particular, when the maximum transmittable torque that is transmitted with a slippage of 1 and the torque due to the nominal load can be absorbed by the brake with sufficient safety.

In conjunction with a hysteresis clutch that is configured so as to be adjustable in view of its torque limit, there is the additional possibility of the controlled load lowering in an error situation. To accomplish this, the motor is blocked with a suitable tool or object so that it can no longer rotate. If a motor-side brake is provided, such brake may also be used to block the motor. Then the torque limit of the hysteresis clutch is slightly reduced by manual adjustment, and then the manual release of the transmission-side brake is tried. This is repeated until the torque limit has been reduced to a point at which the load is capable of at least slowly rotating the hysteresis clutch. Once this adjustment has been achieved, the transmission-side brake may be held manually released until the load has been deposited in a controlled manner on the ground or on another support. In doing so, an uncontrolled clutch slip of the load is excluded due to the positive slope of the torque/slippage characteristic.

Other objects and advantages of the invention will become apparent upon reading the following detailed description and upon reference to the drawings.

### BRIEF DESCRIPTION OF THE DRAWINGS

FIG. 1 a schematic of a hoist in accordance with the invention;

FIG. 2 is a more detailed schematic the illustrated hoist;

FIG. 3 is a vertical section of an embodiment of the illustrated hoist;

FIG. 4 is a torque/slippage characteristic chart of the operation of the illustrated hoist;

FIGS. 5 and 6 are time-dependency diagrams of the rates of revolution of the input and output of a clutch of the illustrated hoist with different loads; and

FIG. 7 is a time-dependency diagram of the torques on the clutch with the occurrence of load vibrations.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE PREFERRED EMBODIMENTS

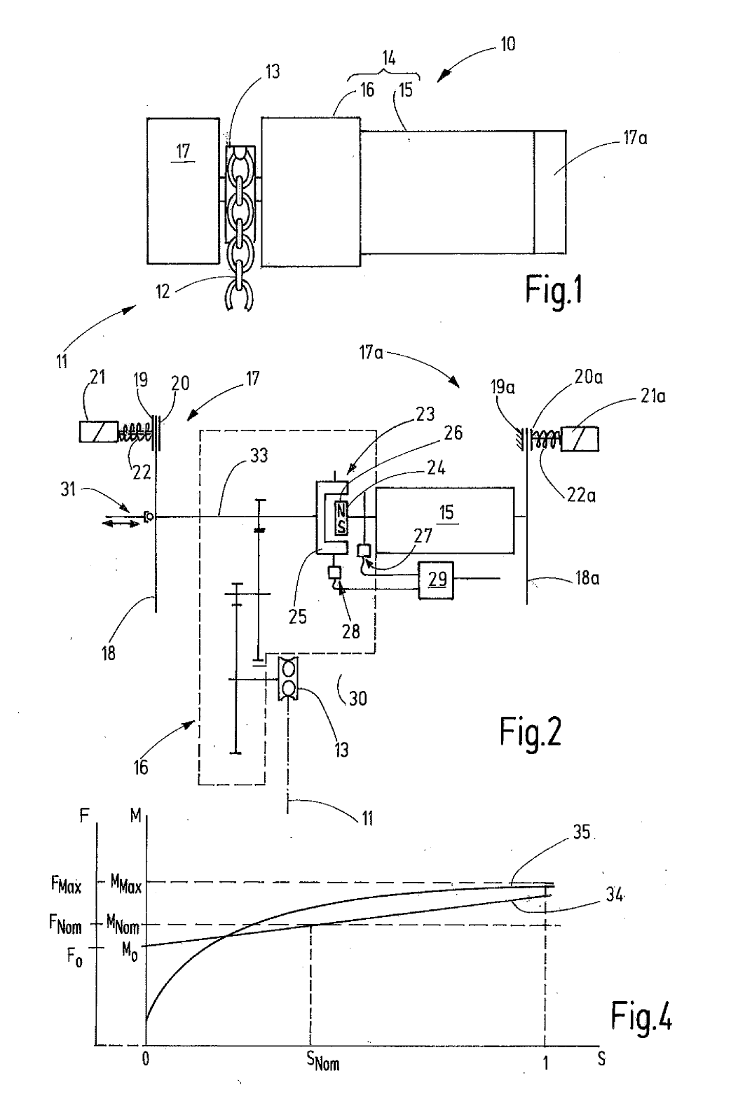

Referring now more particularly to FIG. 1, there is shown an illustrative hoist 10 in accordance with the invention which, as will be understood by a person skilled in the art, may be part of a crane, a crane system or the like and is disposed to lift loads by means of a pulling element or means 11, e.g., in the form of a round link chain 12, another type of chain, a rope or the like. To do so, the chain 12 moves over a pocket wheel 13 that is connected to the output side of a powertrain 14. The powertrain 14 comprises a motor 15, preferably an electric motor, as well as, preferably, a transmission 16. For all embodiments of the hoist 10, the motor 15 may be an asynchronous motor, a synchronous motor or another electric motor, a hydraulic motor, a compressed air motor or any other drive source. In the simplest case, this may be a mains-operated motor with a single fixed rotational speed, whereby the motor can be switched on and off Alternatively, by pole changing, the motor 15 can assume several rotational speeds as a mains-operated motor. In a particularly convenient embodiment, the motor 15 is operated at variable rotational speeds by means of an inverter.

The transmission 16 is a reduction gear 16 that transforms a high rate of revolutions of the motor into a low rate of revolutions of the pocket wheel 13 in order to raise and lower loads. Preferably, the transmission 16 is a non-self-locking toothed gearing. However, if needed, it may also comprise self-locking components such as a worm gear.

The powertrain 14 is connected to a transmission-side brake 17. Preferably, this may be a disk brake comprising a brake disk 18 that is associated with brake blocks 19, 20. Preferably, these are tensioned by the force of a spring 22 toward the brake disk 18. They may be released by one or more electromagnets 21 in order to free the brake disk 18.

As shown schematically in FIG. 2, the transmission 16 is a reduction gear that is connected to the motor 15 via a hysteresis clutch 23. To do so, the hysteresis clutch 23 comprises an input-side clutch half 24 that is connected to the drive shaft of the motor 15 and a transmission-side drive half 25 that is connected to the input shaft of the transmission 16. One of the shafts of the transmission 16 is connected to the brake 17. Preferably, the hysteresis clutch 23 has a basic cylindrical design with a cylindrical air gap 26 that is included between the clutch halves 24, 25.

Optionally, at least one of the clutch halves 24, 25 may be connected to a rotational speed sensor; in the simplest case, this is a centrifugal switch. Alternatively, it is also possible to connect both clutch halves 24, 25 to rotational speed sensors 27, 28, each generating a signal corresponding to the rotational speed of the clutch halves 24 and 25, respectively. The signals may be switching signals, analog signals or digital signals that characterize the rotational speed and/or the phase relationship of the clutch halves 24, 25 to each other. The signals may be input in a unit 29 for determining the rotational speed, detecting slippage and/or determining slippages. The detected slippage and/or the rotational speed(s) can be utilized as control criterion for operating the motor 15 and/or the brake 17. The load quantity can be determined based on the slippage.

As shown schematically in FIG. 2, the hysteresis clutch 23 and the transmission 16 may be arranged in a common transmission housing 30 that is preferably filled with oil. The oil may be used for the lubrication of bearings and cogged wheels as well as for discharging waste heat generated in the transmission housing 30. In particular, the existing oil may be used to transmit the waste heat of the hysteresis clutch 23 to the transmission housing 30.

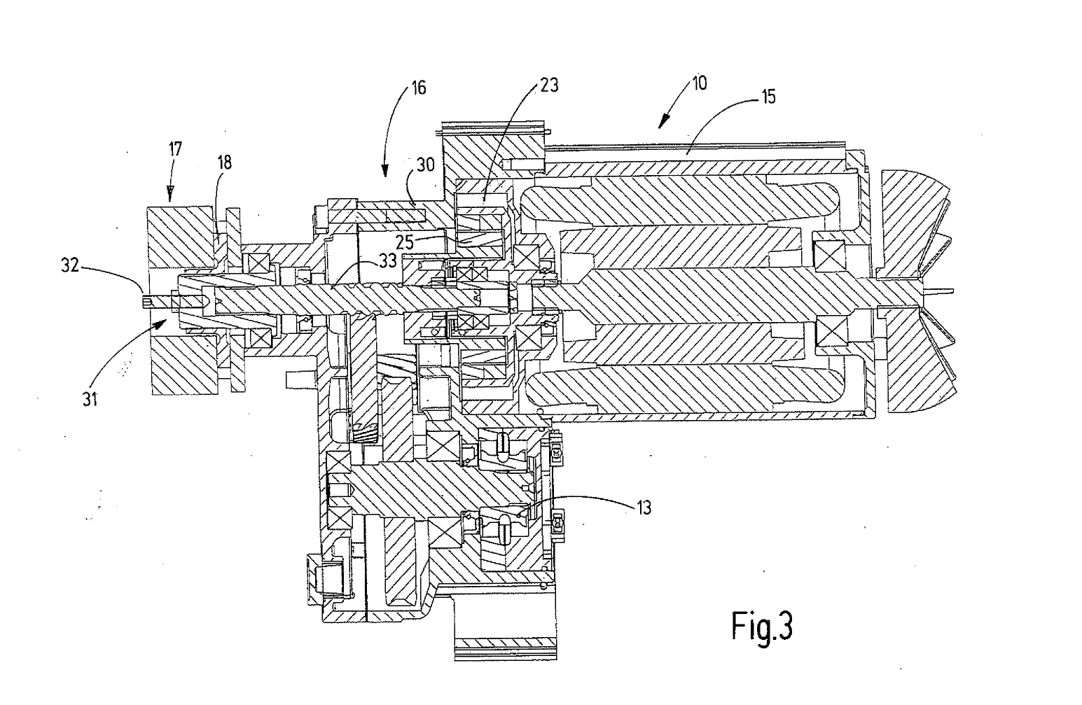

With reference to FIG. 3, the design of the hoist 10 with the brake 17 on the transmission side is shown in greater detail. As will be understood by a person skilled in the art, the hoist 10 comprises an adjustment arrangement 31 for adjusting the hysteresis clutch 23. The adjustment arrangement 31 comprises an adjusting screw 32 that supports a shaft 33 connected to the transmission-side clutch half 25. By adjusting the axial position of the shaft 33, the relative axial positions of the clutch halves 24, 25 are adjusted relative to each other, and, consequently, the size of the air gap 26 is adjusted.

The hoist 10 described thus far operates as follows:

The hoist 10 can be used for moving loads (lifting or even pulling in an inclined or horizontal direction), with the loads being connected to the pulling means 11. This may take place on the free end of the pulling means 11 or via a loose roller arranged in a snatch block if the free end of the pulling means 11 is fastened at a fixed suspension point, e.g., the transmission housing 30. When the motor 15 rotates, it transmits the driving torque—via the hysteresis clutch 23 and the transmission 16—to the pocket wheel 13 or to another winding wheel in order to lift or otherwise move the load. If the weight of the load is lower than a force limit F0, this action may take place without any substantial slippage of the hysteresis clutch 23. If the weight of the load is greater than the force limit F0, but smaller than the nominal load-bearing capacity FNom, a slippage occurs on the hysteresis clutch 23. The force limit F0 on the hysteresis clutch 23 corresponds to a torque limit M0. When this torque limit M0 is reached, the slippage s is just still zero. When the torque limit M0 is exceeded, said slippage increases. In so doing, the hysteresis clutch 23 preferably shows a linear characteristic 34, i.e., the transmitted torque M increases with increasing slippage s. When the nominal load-bearing capacity FNom is reached, the nominal torque MNom is applied to the hysteresis clutch 23, this resulting in the slippage sNom. The nominal slippage sNom ranges between 0 and 1. For example, it may be 5% or 10% greater. Preferably, it is selected in such a manner that the nominal load can still be lifted smoothly, however at a clearly reduced speed, in order to signal to the operator that the nominal load has been reached.

If higher speeds (e.g., nominal speed) are to be reached with nominal load, the gear reduction may be accomplished, i.e., set in such a manner that, despite slippage, the desired higher speed is reached. The advantage of such a selection of transmission is that partial loads can be moved more rapidly and that the work efficiency is thus increased.

It should be noted that the torque/slippage characteristic must not necessarily be linear. As indicated in FIG. 4 as the torque/slippage characteristic 35, it may also deviate from the straight form, so that—in cases of critical loads lower than half the nominal load-bearing capacity FNom—a slippage different from zero will already occur. However, preferably, such characteristics are digressive in order to generate—in case of a slippage equal to 1, i.e., when the pulling means 11 is blocked—a maximum force FMax , said force being limited to a safe value and, for example, not exceeding 1.5 times, preferably 1.3 times, further preferably at most 1.2 times, further at most 1.1 times the nominal load-bearing capacity FNom or a value of the nominal load between said values. If there exists a maximum force FMax, the maximum torque MMax occurs on the hysteresis clutch 23. Irrespective of whether the torque/slippage characteristic 34 is linear or whether it is a non-linear torque/slippage characteristic 35, it is possible—by detecting the rotational speeds of at least the clutch half 25 (e.g., by means of a centrifugal switch), preferably both clutch halves 25, 24, by means of rotational speed sensors 27, 28—to determine the slippage and draw a conclusion regarding the operating status of the hoist 10 or to influence said operating status. For example, it is possible to lower the rotational speed of the motor 15 if the nominal slippage sNom is exceeded in order to thus prevent the lifting of loads that are greater than the nominal load-bearing capacity FNom, without, however, completely switching off the motor 15.

Furthermore, by setting the torque limit M0 lower than the torque limit MNom a smooth operation 10 can be achieved even if the motor 15 is operated without an inverter with mains current at a fixed rotational speed.

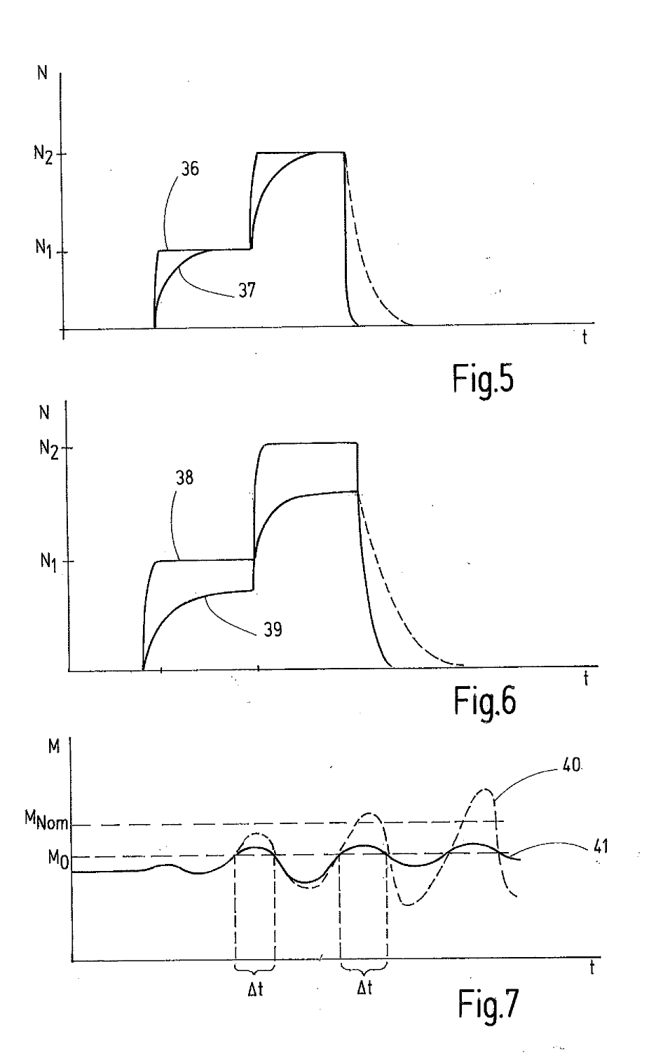

FIG. 5 illustrates the switching on of a motor 15 that can be operated at two rotational speeds N1, N2. The characteristic 36 shows the progression of the motor rotational speed and thus the rotational speed of the clutch half 24. The characteristic 37 shows the progression of the rotational speed of the clutch half 25. While the load is being accelerated, the slippage s briefly increases, so that the rotational speed of the transmission-side clutch half 25 follows the rotational speed of the motor 15 with a delay. In this manner, a shock-like stress of the pulling means 11 is prevented or minimized. The effect is analogous even in case of a motor 15 that is to be operated only at a single fixed rotational speed. As is apparent, the hysteresis clutch 23 reaches the slippage 0, i.e., the load that is lower than the load F0, after a certain time.

FIG. 6 shows the operation at a weight of the load greater than the load limit F0. While the motor rotational speed virtually surges (characteristic 38), the rotational speed of the transmission-side clutch half 25 follows with a noticeable delay, without ever reaching the rotational speed of the motor. Consequently, the operation of the hoist 10 is especially gentle as the nominal load-bearing capacity FNom is being approached.

With the use of the optional motor-side brake 17a—either as the only brake or in combination with the transmission-side brake—a shock-like stress of the pulling means 11 can also be prevented or minimized during a stopping operation. FIG. 2 shows the optional brake 17a. The brake comprises a brake disk 18a, brake blocks 10a, 20a, a return spring 22a and an electromagnet 21a that releases the brake 17a against the force of the return spring 22a.

If two brakes 17, 17a are being used, they must be activated in such a manner that, first, the motor-side brake 17a is braking and, subsequently—delayed—the transmission-side brake 17 is braking. After the motor-side brake 17a has been actuated, the motor rotational speeds 36 and 38 drop rapidly. The load is decelerated gently by the hysteresis clutch 23 that now acts like a hysteresis brake. The gentle deceleration of the load is shown by dashed lines in FIGS. 5 and 6. Following the delayed application of the transmission-side brake 17, the load is held safely by the transmission-side brake 17. The described hoist comprising two brakes supports the option of a controlled lowering of the load.

FIG. 7 illustrates another useful effect achieved with the hoist 10. This is shown by a torque/time diagram that characterizes the progression of the torque M on the hysteresis clutch 23 in the case of a stimulation of vibrations. Such a stimulation of vibrations can be due to the polygonal effect of the pocket wheel 13. If the rotating pocket wheel 13 that is polygonal in its effect stimulates the chain 12 at a frequency corresponding to the resonant frequency of the tensioned chain, severe oscillations of the chain may occur. They manifest themselves in corresponding torque fluctuations that can lead to the damage of the drive and major components such as, e.g., the supporting structures. FIG. 7 shows, in a dashed line 40, a thusly resulting torque progression during which the nominal torque MNom and thus also the corresponding nominal load-bearing capacity FNom would be exceeded. However, the torque on the hysteresis clutch 23 as depicted by the solid line 41 repeatedly reaches, in time segments Δt, a zone between the torque limit M0 and the nominal torque MNom. In this zone, the slippage s is different from 0 so that the energy is withdrawn from the vibration process and transformed into thermal energy. As a result of this, the vibration is effectively attenuated so that it stops completely or that at least the nominal torque MNom (and thus the nominal load-bearing capacity FNom) is not exceeded.

From the foregoing, it can be seen that the hoist 10 in accordance with the invention includes a powertrain 14 that comprises a hysteresis clutch 23. The clutch transmits torques of a driving motor 15 to a transmission 16 and, in so doing, drives a pulling means 11. The hysteresis clutch 23 is adjusted in such a manner that it exhibits a slippage clearly different from zero already before the nominal load-bearing capacity FNom on the pulling means is reached. If the hoist is operated within the range of or near its nominal load-bearing capacity FNom , the device operates at continuous slippage. The resultant waste heat is preferably discharged, via an oil bath, to the wall of the transmission housing which, in so doing, acts as a cooling surface.

The subject hoist 10 allows slimmer dimensioning and displays improved operating properties. Its hysteresis clutch 23 allows the use as a hysteresis brake with controlled emergency load lowering; it acts as a vibration damper for absorbing load vibrations; it can act as a safe torque-limiting unit in the case of an emergency switch-off while the load is being stopped by means of the transmission-side brake 17 and the motor 16 is continued to be operated, and/or it can act for the operator as a load indicator as a result of load-dependent changes of the load lifting rate at constant motor rotational speed.

### LIST OF REFERENCE SIGNS

10 Hoist
11 Pulling means
12 Chain
13 Pocket wheel
14 Powertrain
15 Driving motor
16 Transmission
17, 17a Brake
18, 18a Brake disk
19, 20
19a, 20a Brake block
21, 21a Electromagnet
22, 22a Spring
23 Hysteresis clutch
24 Motor-side clutch half
25 Transmission-side clutch half
26 Air gap
27 Rotational speed sensor, motor and clutch half 24, resp.
28 Rotational speed sensor, transmission and clutch half 25, resp.
29 Slippage detection unit
NMotor Motor rotational speed
NGetriebe [Transmission] Transmission rotational speed
s Slippage: s=(NMotor−NTransmission)/NMotor
30 Transmission housing
31 Adjustment arrangement
32 Adjusting screw
33 Shaft
F0 Force limit
FNom Nominal load-bearing capacity
M0 Torque limit
MNom Nominal torque
sNom Nominal slippage
34 Torque/slippage characteristic—linear
35 Torque/slippage characteristic—non-linear
FMax Maximum force
MMax Maximum torque
N1, N2 Motor rotational speeds
36 Motor rotational speed
37 Rotational speed, transmission input shaft
38 Motor rotational speed
39 Rotational speed, transmission input shaft
40, 41 Line

1-15. (canceled)

16. A hoist (10) comprising:
a powertrain (14) including a motor (15) for applying a driving torque and a transmission (16);
a pulling element (11) connected to the powertrain (14) for lifting a load;
a hysteresis clutch (23) arranged in the powertrain (14) having a torque limit (M0), below which said clutch does not display any slippage and above which it operates at a slippage (s);
said hoist (10) having a nominal load-bearing capacity (FNom) which corresponds a nominal load torque (MNom) on the hysteresis clutch (23); and
said nominal load torque (MNom) on the hysteresis clutch (23) being greater than the torque limit (M0) of the hysteresis clutch (23).

17. The hoist of claim 16 in which said torque limit (M0) of the hysteresis clutch (23) is at most 0.95 times the nominal load torque (MNom).

18. The hoist of claim 16 in which said torque limit (M0) of the hysteresis clutch (23) is at most 0.8 times the nominal load torque (MNom).

19. The hoist of claim 16 in which a maximum torque (MMax) of the hysteresis clutch (23) incurs in lifting a load is at most 1.3 times the nominal load torque (MNom).

20. The hoist of claim 16 in which the maximum torque (MMax) the hysteresis clutch (23) incurs is at most 1.1 times the nominal load torque (MNom).

21. The hoist of claim 16 in which said hysteresis clutch (23) is operable with an increasing transmitted torque with increasing slippage (s).

22. The hoist of claim 16 in which said hysteresis clutch (23) is operable with a slippage (s) that is at least 0.05 at nominal load-bearing capacity (FNom) when the torque limit (M0) is exceeded.

23. The hoist of claim 16 in which the pulling element (11) is a chain (12), said powertrain (14) including a pocket wheel (13) for driving the chain (12), and said motor (15) being operable at least two different rotational speeds (N1, N2).

24. The hoist of claim 16 including at least one rotational speed sensor (28) connected to the hysteresis clutch (23).

25. The hoist of claim 24 including an analyzing unit (29) connected to said at least one rotational speed sensor for detecting slippage and/or load detection.

26. The hoist of claim 16 in which said hysteresis clutch (23) is arranged in an oil bath.

27. The hoist of claim 16 in which said hysteresis clutch (23) has an air gap (26) between an inner clutch half (24) and an outer clutch half (25).

28. The hoist of claim 27 in which said inner clutch half (24) has at least one permanent magnet, and said outer clutch half (25) includes a material having a polarity that can be reversed by the at least one permanent magnet.

29. The hoist of claim 16 in which said hysteresis clutch (23) has a size-adjustable air gap (26) between said inner and outer clutch halves (24, 25).

30. The hoist of claim 29 in which hysteresis clutch (23) includes a manual adjustment mechanism (31) for adjusting said air gap.

31. The hoist of claim 16 in which said powertrain (14) includes at least one brake (17, 17a) connected to the transmission (16).

32. The hoist of claim 31 in which said brake (17) is operable for effecting a brake torque that is at least as great as the maximum load torque (Mmax) the hysteresis clutch (23) or the motor (15) can incur, depending on whichever is lower.

33. The hoist of claim 16 in which said hysteresis clutch (23) is operable as at least one of a hysteresis brake with controlled emergency load lowering, a vibration damper for absorbing load vibrations, a safe torque limiter in the event of an emergency switch-off when the load is being stopped by means of the transmission-side brake (17) and the motor (16) is continued to be operated, and/or a load indicator. This listing of claims replaces all prior versions, and listings, of claims in the application.
